(19) United States
(12) Patent Application Publication
(10) Pub. No.: US 2025/0154963 A1
(43) Pub. Date: May 15, 2025

(54) SIROCCO FAN AND AIR CONDITIONER

(71) Applicant: LG ELECTRONICS INC., Seoul (KR)

(72) Inventors: Joonmin PARK, Seoul (KR); Taeman YANG, Seoul (KR); Choonmyun CHUNG, Seoul (KR)

(73) Assignee: LG ELECTRONICS INC., Seoul (KR)

(21) Appl. No.: 18/728,638

(22) PCT Filed: Dec. 30, 2022
(86) PCT No.: PCT/KR2022/021724

§ 371 Date: Jul. 12, 2024

(30) Foreign Application Priority Data
Jan. 13, 2022 (KR) 10-2022-0005386

(51) Int. Cl. F04D 29/32; F04D 19/00; F24F 12/00

(52) U.S. Cl. CPC F04D 29/325; F04D 19/002; F24F 12/006

(57) ABSTRACT

The present disclosure relates to a sirocco fan. The sirocco fan according to one aspect of the present disclosure comprises: a first plate into which a rotary shaft of a motor is inserted; a second plate spaced apart from the first plate in the extension direction of the rotary shaft; a third plate disposed between the first plate and the second plate; a first blade extending between the first plate and the third plate and inclined with respect to the rotary shaft; and a second blade extending between the second plate and the third plate and inclined with respect to the rotary shaft. Thus, the static pressure of the sirocco fan can be maintained and efficiency can be improved.

### TECHNICAL FIELD

The present disclosure relates to a sirocco fan, and more specifically, to an impeller for a sirocco fan.

### BACKGROUND ART

An air conditioner is an apparatus that exhausts stale indoor air and supplies fresh outdoor air into an indoor space.

A fan for blowing indoor/outdoor air is disposed inside a case of the air conditioner, and the fan may be a sirocco fan.

However, conventional air conditioners have the problem of noise caused by flow separation at the center of a sirocco fan disposed inside the case.

Another problem with the sirocco fan disposed in the conventional air conditioners is that a static pressure cannot be maintained due to flow separation at an intake side. Moreover, the sirocco fan is problematic in that air cannot be blown at a sufficient flow rate due to flow separation at a discharge side.

### DETAILED DESCRIPTION OF INVENTION

### Technical Problems

The present disclosure has been made in an effort to solve the aforementioned problems and other problems.

Another object of the present disclosure is to provide a sirocco fan that offers improved blowing performance.

Yet another object of the present disclosure is to provide a sirocco fan that makes less noise.

A further another object of the present disclosure is to provide a sirocco fan that maintains a static pressure.

A further another object of the present disclosure is to provide an air conditioner that offers improved blowing performance.

A further another object of the present disclosure is to provide an air conditioner that makes less noise.

The objects of the present disclosure are not limited to the foregoing, and other objects not mentioned herein will be able to be clearly understood by those skilled in the art from the following description.

### Technical Solution

To accomplish the foregoing objects, a sirocco fan according to one aspect of the present disclosure includes a first plate into which a rotary shaft of a motor is inserted.

The sirocco fan includes a second plate spaced apart from the first plate in the extension direction of the rotary shaft.

The sirocco fan includes a third plate disposed between the first plate and the second plate.

The sirocco fan includes a first blade extending between the first plate and the third plate.

The first blade may be inclined with respect to the rotary shaft.

The sirocco fan includes a second blade extending between the second plate and the third plate.

The second blade may be inclined with respect to the rotary shaft.

The direction in which the first blade is inclined toward the third plate may be identical to the direction in which the second blade is inclined toward the third plate.

The first blade and the second blade may be inclined in the direction of rotation of the rotary shaft, nearing the third plate.

The first blade may include a first outer end portion adjoining the first plate.

The first blade may include a first inner end portion adjoining the third plate, at a position spaced apart from the first outer end portion in the direction of rotation of the rotary shaft.

The second blade may include a second outer end portion adjoining the second plate.

The second blade may include a second inner end portion adjoining the third plate, at a position spaced apart from the second outer end portion in the direction of rotation of the rotary shaft.

The first blade and the second blade may be inclined in a direction opposite to the direction of rotation of the rotary shaft, nearing the third plate.

The first blade may include a first inner end portion adjoining the third plate, at a position spaced apart from the first outer end portion in a direction opposite to the direction of rotation of the rotary shaft.

The second blade may include a second inner end portion adjoining the third plate, at a position spaced apart from the second outer end portion in a direction opposite to the direction of rotation of the rotary shaft.

The angle at which the first blade and the second blade are inclined with respect to the rotary shaft is 15 degrees or smaller.

An air conditioner according to an aspect of the present disclosure includes a case formed with an outside air inlet opening and an outside air supply opening.

The air conditioner includes a total heat exchanger disposed between the outside air inlet opening and the outside air supply opening.

The air conditioner includes an air supply fan disposed between the outside air supply opening and the total heat exchanger.

The air conditioner includes an air supply fan motor having a rotary shaft that is coupled to the air supply fan.

The first blade and the second blade may be inclined toward a downstream side of the total heat exchanger, nearing the third plate.

The first blade and the second blade may be inclined toward an upstream side of the total exchanger, nearing the third plate.

Specific details of other embodiments are included in the detailed description and the drawings.

### Effect of Invention

According to at least one of the embodiment of the present disclosure, the blowing performance can be improved by means of the angle of inclination between the first blade and the second blade.

According to at least one of the embodiment of the present disclosure, noise can be reduced by means of the angle of inclination between the first blade and the second blade.

According to at least one of the embodiment of the present disclosure, the static pressure of the sirocco fan can be maintained by means of the angle of inclination between the first blade and the second blade.

According to at least one of the embodiment of the present disclosure, the blowing performance of the air conditioner can be improved.

The objects of the present disclosure are not limited to the foregoing, and other objects not mentioned herein will be able to be clearly understood by those skilled in the art from the following description.

### BRIEF DESCRIPTION OF THE DRAWING

FIG. 1 is a perspective view of an air conditioner according to one embodiment of the present disclosure.

FIG. 2 is a view showing an internal structure of an air conditioner according to an embodiment of the present disclosure.

FIG. 3 is a front view of a fan according to an embodiment of the present disclosure.

FIG. 4 is a side view of a fan according to an embodiment of the present disclosure.

FIG. 5 is a front view of a fan according to an embodiment of the present disclosure.

FIG. 6 shows contours depicting effects of a fan according to an embodiment of the present disclosure.

FIG. 7 is a graph depicting an effect of a fan according to an embodiment of the present disclosure.

FIG. 8 is a graph depicting an effect of a fan according to an embodiment of the present disclosure.

### BEST MODE FOR CARRYING OUT THE INVENTION

Hereinafter, the embodiments disclosed in the present specification will be described in detail with reference to the accompanying drawings, but the same or similar components are assigned the same reference numerals regardless of reference numerals, and overlapping descriptions thereof will be omitted.

The suffixes “module” and “part” for the components used in the following description are given or mixed in consideration of only the ease of writing the specification, and do not have distinct meanings or roles by themselves.

In describing the embodiments disclosed in the present specification, if it is determined that detailed descriptions of related known technologies may obscure the gist of the embodiments disclosed in the present specification, the detailed descriptions thereof will be omitted. In addition, the accompanying drawings are only for easy understanding of the embodiments disclosed in the present specification, and the technical spirit disclosed in the present specification is not limited by the accompanying drawings, and it should be understood that the present disclosure includes all changes, equivalents and substitutes included in the spirit and technical scope of the present disclosure.

Terms including ordinal numbers such as first, second, etc. may be used to describe various constituent elements, but the constituent elements are not limited by the terms. The above terms are used only for the purpose of distinguishing one constituent element from another.

When one constituent element is mentioned as being “coupled” or “connected” to another constituent element, it should be understood that one constituent element can be coupled or connected directly to another constituent element, but another constituent element can also be present between the constituent elements. Meanwhile, when one constituent element is mentioned as being “coupled directly to” or “connected directly to” another constituent element, it should be understood that another constituent element is not present between the constituent elements.

Singular expressions include plural expressions unless clearly described as different meanings in the context.

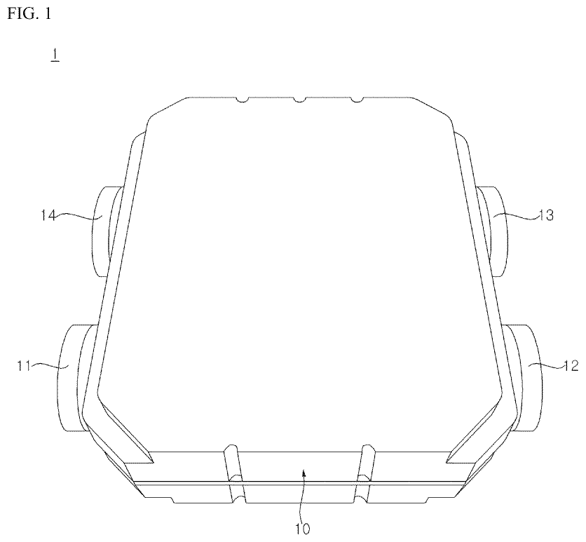

An outward appearance of an air conditioner will be described with reference to FIG. 1.

The air conditioner 1 includes a case 10. The case 10 may have a space inside it.

The case 10 may include an outside air inlet opening 11 that communicates with the outside of the case 10. The outside air inlet opening 11 may communicate with an outdoor space. Fresh air from the outdoor space may be admitted into the case 10 through the outside air inlet opening 11.

The case 10 may include an outside air supply opening 12 that communicates with the outside of the case 10. The outside air supply opening 11 may communicate with the indoor space. Fresh air from the outdoor space may be admitted into the indoor space through the outside air supply opening 12.

The case 10 may include an inside air inlet opening 13 that communicates with the outside of the case 10. The inside air inlet opening 13 may communicate with the indoor space. Stale air from the indoor space may be admitted into the case 10 through the inside air inlet opening 13.

The case 10 may include an inside air exhaust opening 14 that communicates with the outside of the case 10. The inside air exhaust opening 14 may communicate with the outdoor space through the inside air exhaust opening 14.

An internal structure of the air conditioner 1 will be described.

The air conditioner 1 includes a total heat exchanger 20 that is disposed inside the case 10. The total heat exchanger 20 may transfer heat between outside and inside air admitted into the case 10.

The case 10 may include a first wall 15. The first wall 15 may be disposed on one side of the total heat exchanger 20.

The case 10 may include a second wall 16. The second wall 16 may be spaced apart from the first wall 15. The second wall 16 may be disposed on the side opposite to the first wall 15 with respect to the total heat exchanger 20. The total heat exchanger 20 may be disposed between the first wall 15 and the second wall 16. The second wall 16 may be disposed on the other side of the total heat exchanger 20 opposite to the first wall 15.

The total heat exchanger 20 may extend between the first wall 15 and the second wall 16. The lengthwise direction of the total heat exchanger 20 may be a direction toward the second wall 16 from the first wall 15.

The case 10 may include a third wall 17. The third wall 17 may connect the first wall 15 and the second wall 16. The third wall 17 may extend in a direction that intersects the first wall 15 and the second wall 16. The third wall 17 may be spaced apart from the total heat exchanger 20.

The outside air inlet opening 11 may be formed through the third wall 17. The outside air exhaust opening 11 may be open toward the total heat exchanger 20. The outside air exhaust opening 11 may be open toward the outdoor space.

The inside air exhaust opening 14 may be formed through the third wall 17. The inside air exhaust opening 14 may be open toward the total heat exchanger 20. The inside air exhaust opening 14 may be open toward the outdoor space.

The case 10 may include a fourth wall 18. The fourth wall 18 may connect the first wall 15 and the second wall 16. The fourth wall 18 may extend in a direction that intersects the first wall 15 and the second wall 16. The fourth wall 18 may be spaced apart from the total heat exchanger 20. The fourth wall 18 may be spaced apart from the third wall 17.

The outside air supply opening 12 may be formed through the fourth wall 18. The outside air supply opening 12 may be open toward the total heat exchanger 20. The outside air supply opening 12 may be open toward the indoor space.

The inside air inlet opening 13 may be formed through the fourth wall 18. The inside air inlet opening 13 may be open toward the total heat exchanger 20. The inside air inlet opening 13 may be open toward the indoor space.

The air conditioner 1 may include an air supply fan 30 that is disposed between the case 10 and the total heat exchanger 20. The air supply fan 30 may rotate by being coupled to an air supply fan motor 31. The air supply fan 30 may be disposed between the fourth wall 18 and the total heat exchanger 20. The air supply fan 30 may be disposed between the total heat exchanger 20 and the outside air supply opening 12. After exchanging heat at the total heat exchanger 20, air may be exhausted to the outdoor space by the air supply fan 30.

The air supply fan 30 may rotate by power provided from the air supply fan motor 31. The air supply fan motor 31 may include a rotary shaft 31a that is coupled to the air supply fan 30. The rotary shaft 31a of the air supply fan motor 31 may be named “air supply fan rotary shaft”.

The air conditioner 1 may include an air supply fan housing 40 that surrounds the air supply fan 30. The air supply fan housing 40 may be disposed between the case 10 and the total heat exchanger 20. The air supply fan housing 40 may be disposed between the fourth wall 18 and the total heat exchanger 20.

The air conditioner 1 may include an exhaust fan 50 that is disposed between the case 10 and the total heat exchanger 20. The exhaust fan 50 may rotate by being coupled to an exhaust fan motor 51. The exhaust fan 50 may be disposed between the third wall 17 and the total heat exchanger 20. The exhaust fan 50 may be disposed between the total heat exchanger 20 and the inside air exhaust opening 14. After exchanging heat at the total heat exchanger 20, air may be exhausted to the outdoor space by the exhaust fan 50.

The exhaust fan 50 may rotate by power provided from the exhaust fan motor 51. The exhaust fan motor 51 may include a rotary shaft 51a that is coupled to the exhaust fan 50. The rotary shaft 51a of the exhaust fan motor 51 may be named “exhaust fan rotary shaft”.

The air conditioner 1 may include an exhaust fan housing 60 that surrounds the exhaust fan 50. The exhaust fan housing 60 may be disposed between the case 10 and the total heat exchanger 20. The exhaust fan housing 60 may be disposed between the third wall 17 and the total heat exchanger 20.

The air supply fan 30 may include a first plate 32 that is connected to the air supply fan motor 31. The first plate 32 may be disc-shaped. The air supply fan rotary shaft 31a may penetrate the first plate 32.

The air supply fan 30 may include a second plate 33 that is spaced apart from the first plate 32. The second plate 32 may be ring-shaped. The second plate 33 may be disposed in parallel to the first plate 32.

The air supply fan 30 may include a third plate 34 that is disposed between the first plate 32 and the second plate 33. The third plate 34 may be ring-shaped. The third plate 34 may be disposed in parallel to the first plate 32.

The air supply fan 30 may include a first blade 35 that extends between the first plate 32 and the third plate 34. The first blade 35 may be arc-shaped. The first blade 35 may be inclined with respect to the direction of rotation of the rotary shaft 31a. An angle θ of inclination may be formed between the first blade 35 and the rotary shaft 31a. The first blade 35 may be inclined in the direction of rotation of the rotary shaft 31a as it nears the third plate 34. The first blade 35 may be inclined toward a downstream side of air discharged through the total heat exchanger 20 as it nears the third plate 34. The first blade 35 may be inclined toward the outside air supply opening 12 as it nears the third plate 34.

The air supply fan 30 may include a second blade 36 that extends between the second plate 33 and the third plate 34. The second blade 36 may be arc-shaped. The second blade 36 may be inclined with respect to the direction of rotation of the rotary shaft 31a. An angle θ of inclination may be formed between the second blade 36 and the rotary shaft 31a. The second blade 36 may be inclined in the direction of rotation of the rotary shaft 31a as it nears the third plate 34. The second blade 36 may be inclined toward a downstream side of air discharged through the total heat exchanger 20 as it nears the third plate 34. The second blade 36 may be inclined toward the outside air supply opening 12 as it nears the third plate 34.

The exhaust fan 50 may include a first plate 52 that is connected to the exhaust fan motor 51. The first plate 52 may be disc-shaped. The exhaust fan rotary shaft 51a may penetrate the first plate 52.

The exhaust fan 50 may include a second plate 53 that is spaced apart from the first plate 52. The second plate 53 may be ring-shaped. The second plate 53 may be disposed in parallel to the first plate 52.

The exhaust fan 50 may include a third plate 54 that is disposed between the first plate 52 and the second plate 53. The third plate 54 may be ring-shaped. The third plate 54 may be disposed in parallel to the first plate 52.

The exhaust fan 50 may include a first blade 55 that extends between the first plate 52 and the third plate 54. The first blade 55 may be arc-shaped. The first blade 55 may be inclined with respect to the direction of rotation of the rotary shaft 51a. An angle θ of inclination may be formed between the first blade 55 and the rotary shaft 51a. The first blade 55 may be inclined in the direction of rotation of the rotary shaft 51a as it nears the third plate 54. The first blade 55 may be inclined toward a downstream side of air discharged through the total heat exchanger 20 as it nears the third plate 54. The first blade 55 may be inclined toward the inside air exhaust opening 14 as it nears the third plate 34.

The exhaust fan 50 may include a second blade 56 that extends between the second plate 53 and the third plate 54. The second blade 56 may be arc-shaped. The second blade 56 may be inclined with respect to the direction of rotation of the rotary shaft 51a. An angle θ of inclination may be formed between the second blade 56 and the rotary shaft 51a. The second blade 56 may be inclined in the direction of rotation of the rotary shaft 51a as it nears the third plate 54. The second blade 56 may be inclined toward a downstream side of air discharged through the total heat exchanger 20 as it nears the third plate 54. The second blade 56 may be inclined toward the inside air exhaust opening 14 as it nears the third plate 54.

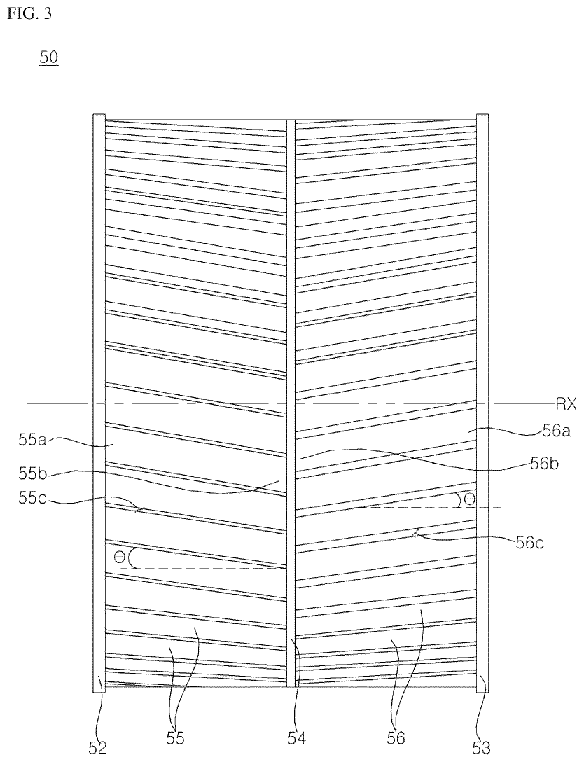

The fan 50 will be described with reference to FIG. 3.

The description of the exhaust fan 40 given with reference to FIG. 3 may apply equally to the air supply fan 30. The air supply fan 30 may have the same structure and shape as the exhaust fan 50. The air supply fan 30 and the exhaust fan 50 may be named “fan”.

The fan 50 may have an axial direction RX which is a direction in which the rotary shaft 51a extends. The fan 50 may rotate about the axial direction RX. The first blade 55 and the second blade 56 may rotate about the axial direction RX.

The first blade 55 may be inclined with respect to the axial direction RX. The second blade 56 may be inclined with respect to the axial direction RX. The first blade 55 may form an angle θ of inclination with the axial direction RX. The second blade 56 may form an angle θ of inclination with the axial direction RX.

The angle θ of inclination between the first blade 55 and the axial direction RX may range from 0 to 15 degrees. The angle θ of inclination between the second blade 56 and the axial direction RX may range from 0 to 15 degrees.

The first blade 55 may extend from the first plate 52 toward the third plate 54. The first blade 55 may include a first outer end portion 55a that is connected to the first plate 52. The first blade 55 may include a first inner end portion 55b that is connected to the third plate 54.

The first inner end portion 55b may be spaced apart from the first outer end portion 55a in the direction of rotation of the rotary shaft 51a. The first inner end portion 55b may be positioned more forward than the first outer end portion 55a with respect to the direction of rotation of the rotary shaft 51a. That is, when the fan 50 rotates, the first inner end portion 55b may come into contact with air earlier than the first outer end portion 55a.

The second blade 56 may extend from the second plate 53 toward the third plate 54. The second blade 56 may include a second outer end portion 56a that is connected to the second plate 53. The second blade 56 may include a second inner end portion 56b that is connected to the third plate 54.

The second inner end portion 56b may be spaced apart from the second outer end portion 56a in the direction of rotation of the rotary shaft 51a. The second inner end portion 56b may be positioned more forward than the second outer end portion 56a with respect to the direction of rotation of the rotary shaft 51a. That is, when the fan 50 rotates, the second inner end portion 56b may come into contact with air earlier than the second outer end portion 56a.

The first blade 55 and the second blade 56 may be alternately arranged with respect to the third plate 54 along the direction of rotation of the fan 50. The first inner end portion 55b and the second inner end portion 56b may alternate on the third plate 54.

A plurality of first blades 55 may be placed in such a way as to be spaced apart from one another in the direction of rotation of the fan 50. A first gap 55c may be formed between the plurality of first blades 55.

A plurality of second blades 56 may be placed in such a way as to be spaced apart from one another in the direction of rotation of the fan 50. A second gap 56c may be formed between the plurality of second blades 56.

The first inner end portion 55b may face the second gap 56c at the third plate 54. The second inner end portion 56b may face the first gap 55c at the third plate 54.

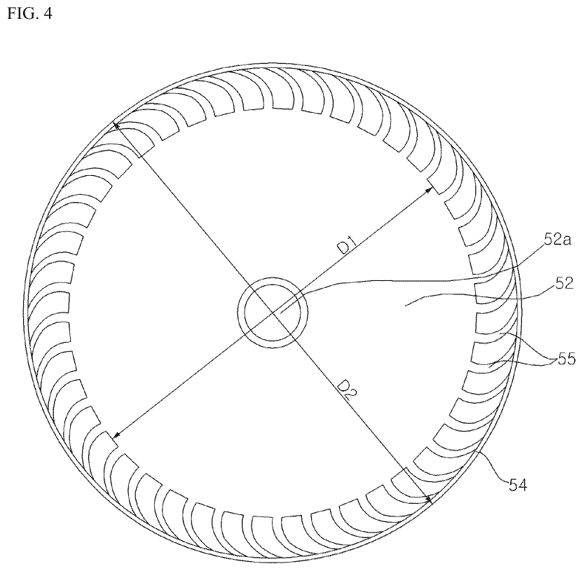

The fan 50 will be described with reference to FIG. 4.

The first plate 52 may be disc-shaped. The first plate 52 may include a rotary shaft insertion portion 52a into which the rotary shaft 51a of the fan motor 51 is inserted.

The first blade 55 may extend between the first plate 52 and the third plate 54.

The diameter D1 of the first plate 52 may be smaller than the diameter D2 of the third plate 54.

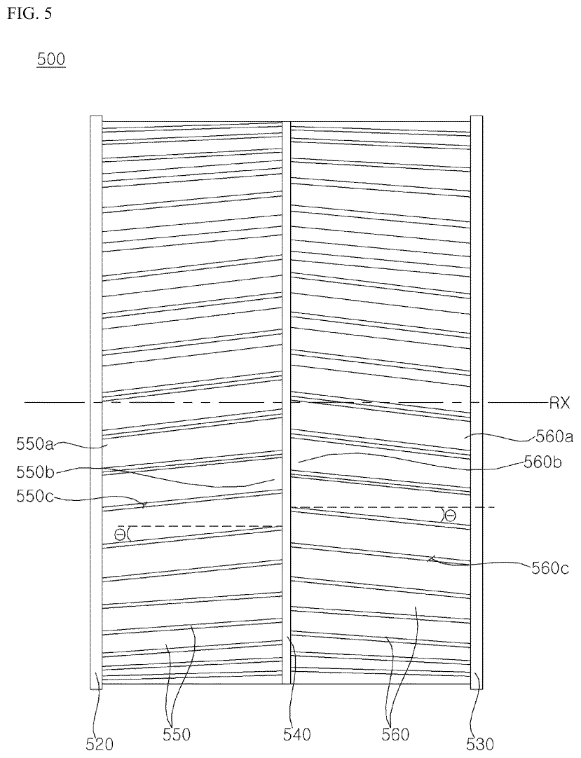

The fan 500 will be described with reference to FIG. 5.

The description of the exhaust fan 500 given with reference to FIG. 5 may apply equally to the air supply fan 30. The air supply fan 30 may have the same structure and shape as the exhaust fan 500. The air supply fan 30 and the exhaust fan 500 may be named “fan”.

The fan 500 may have an axial direction RX which is a direction in which the rotary shaft 51a extends. The fan 500 may rotate about the axial direction RX. The first blade 550 and the second blade 560 may rotate about the axial direction RX.

The first blade 550 may be inclined with respect to the axial direction RX. The second blade 560 may be inclined with respect to the axial direction RX. The first blade 550 may form an angle θ of inclination with the axial direction RX. The second blade 560 may form an angle θ of inclination with the axial direction RX.

The angle θ of inclination between the first blade 550 and the axial direction RX may range from 0 to 15 degrees. The angle θ of inclination between the second blade 56 and the axial direction RX may range from 0 to 15 degrees.

The first blade 550 may extend from the first plate 520 toward the third plate 540. The first blade 550 may include a first outer end portion 550a that is connected to the first plate 520. The first blade 550 may include a first inner end portion 550b that is connected to the third plate 540.

The first inner end portion 550b may be spaced apart from the first outer end portion 550a in a direction opposite to the direction of rotation of the rotary shaft 51a. The first inner end portion 550b may be positioned more rearward than the first outer end portion 550a with respect to the direction of rotation of the rotary shaft 51a. That is, when the fan 500 rotates, the first inner end portion 550b may come into contact with air later than the first outer end portion 550a.

The second blade 560 may extend from the second plate 530 toward the third plate 540. The second blade 560 may include a second outer end portion 560a that is connected to the second plate 530. The second blade 560 may include a second inner end portion 560b that is connected to the third plate 540.

The second inner end portion 560b may be spaced apart from the second outer end portion 560a in a direction opposite to the direction of rotation of the rotary shaft 51a. The second inner end portion 560b may be positioned more rearward than the second outer end portion 560a with respect to the direction of rotation of the rotary shaft 51a. That is, when the fan 50 rotates, the second inner end portion 560b may come into contact with air later than the second outer end portion 560a.

The first blade 550 and the second blade 560 may be alternately arranged with respect to the third plate 540 along the direction of rotation of the fan 500. The first inner end portion 550b and the second inner end portion 560b may alternate on the third plate 540.

A plurality of first blades 550 may be placed in such a way as to be spaced apart from one another in the direction of rotation of the fan 500. A first gap 550c may be formed between the plurality of first blades 550.

A plurality of second blades 560 may be placed in such a way as to be spaced apart from one another in the direction of rotation of the fan 500. A second gap 560c may be formed between the plurality of second blades 560.

The first inner end portion 550b may face the second gap 560c at the third plate 540. The second inner end portion 560b may face the first gap 550c at the third plate 540.

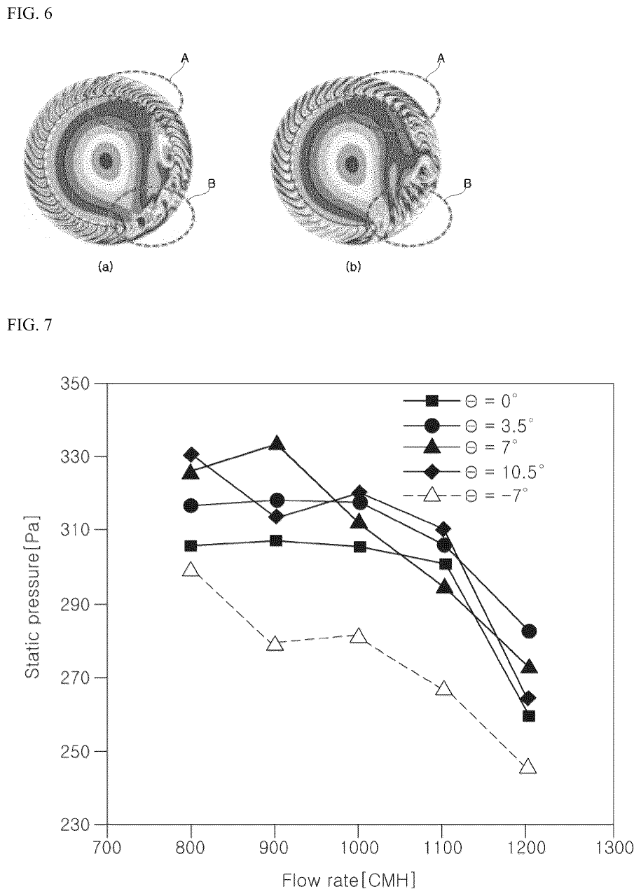

Effects of the present disclosure will be described with reference to FIG. 6.

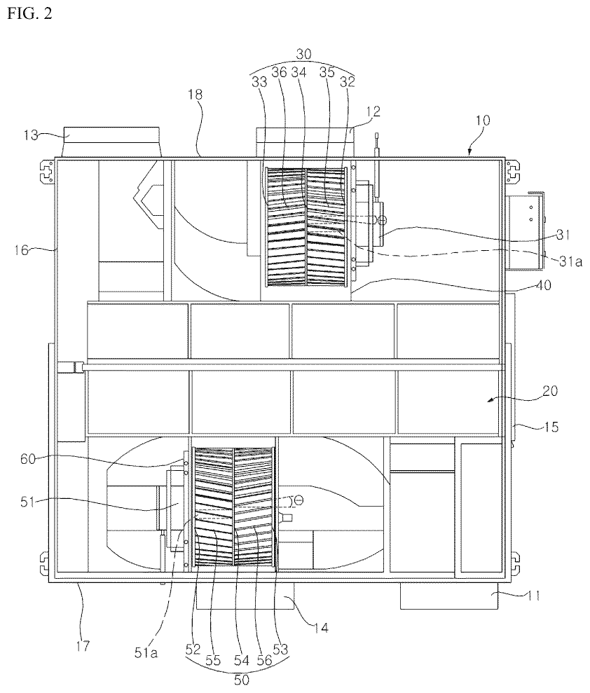

(a) of FIG. 6 shows contours of a flow rate distribution inside a fan, when a fan according to the conventional art is used. (a) and (b) of FIG. 6 show vertical cross-sectional contours at a position contiguous to the third plate 54 explained with reference to FIGS. 1 to 5. That is, (a) and (b) of FIG. 6 show contours of a flow rate distribution at an axial central part of the fan.

Area A shown in FIG. 6 indicates an area where air is drawn. Area B shown in FIG. 6 indicates an area where air is discharged.

Referring to (a) of FIG. 6, it is demonstrated that the flow rate distribution is not uniform in Areas A and B due to flow separation. Hence, the fan according to the conventional art has the problems of lower static pressure efficiency and blowing performance degradation, caused by flow separation.

Referring to (b) of FIG. 6, it is demonstrated that the flow separation in Areas A and B is alleviated. It is also demonstrated that the flow rate distribution in Areas A and B is uniform. Hence, this shows that the static pressure efficiency and blowing performance in Areas A and B are improved.

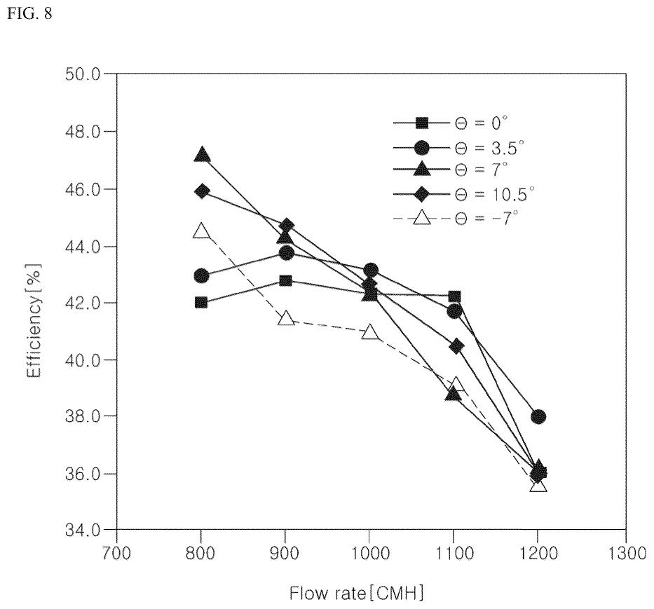

Effects of the present disclosure will be described with reference to FIGS. 7 and 8.

FIG. 7 is a graph of the static pressure of the fan measured by varying the angle θ of inclination shown in FIG. 3. The static pressure may indicate the measure of flow rate distribution at the intake and discharge sides of the fan. FIG. 8 is a graph of the efficiency of the fan measured by varying the angle θ of inclination shown in FIG. 3. The efficiency may indicate a numerical measure of the volume of air blown by the fan relative to the same amount of power.

Referring to FIG. 7, it is demonstrated that the static pressure efficiency is high when the angle θ of inclination ranges from 0 to 15 degrees, as compared to when the angle θ of inclination is 0 degree (conventional art).

Referring to FIG. 8, it is demonstrated that the blowing efficiency is high when the angle θ of inclination ranges from 0 to 15 degrees, as compared to when the angle θ of inclination is 0 degree (conventional art).

While embodiments have been illustrated and described above, the embodiments are not limited to the aforementioned embodiments, and various modifications may be made by a person with ordinary skill in the art to which the embodiments pertain without departing from the subject matter claimed in the claims, and these modifications should not be appreciated individually from the technical spirit or prospect.

The present disclosure may be modified and implemented in various forms, but the scope of the present disclosure is not limited to the above-described embodiments. Therefore, a modified embodiment including the elements of the claims of the present disclosure should be regarded as belonging to the scope of the present disclosure.

It is to be contemplated that the above detailed description is illustrative and not restrictive in all aspects. The scope of the present disclosure should be determined by the reasonable interpretation of the accompanying claims, and all changes that fall within bounds of the claims or equivalence thereof are intended to be embraced by the present disclosure.

While the preferred embodiments have been particularly shown and described, the present specification shall not be limited to the particular embodiments described above, and it will be understood by an ordinary skilled person in the art that various changes in form and details may be made therein without departing from the scope of the present invention as defined by the following claims, and the alternative embodiments should not be individually understood from the inventive concept and prospect of the present disclosure.

It will be apparent to those skilled in the art that various modifications and variations can be made, and thus, the present disclosure should not be construed as being limited to the aforementioned embodiments. Therefore, it is intended that the present disclosure cover the modifications and variations of this disclosure provided they come within the scope of the appended claims and their equivalents.

What is claimed is:

1. A sirocco fan comprising:
a first plate into which a rotary shaft of a motor is inserted;
a second plate spaced apart from the first plate in the extension direction of the rotary shaft;
a third plate disposed between the first plate and the second plate;
a first blade extending between the first plate and the third plate and inclined with respect to the rotary shaft; and
a second blade extending between the second plate and the third plate and inclined with respect to the rotary shaft.

2. The sirocco fan of claim 1, wherein the direction in which the first blade is inclined toward the third plate is identical to the direction in which the second blade is inclined toward the third plate.

3. The sirocco fan of claim 1, wherein the first blade and the second blade are inclined in the direction of rotation of the rotary shaft, nearing the third plate.

4. The sirocco fan of claim 1, wherein the first blade includes:
a first outer end portion adjoining the first plate; and
a first inner end portion adjoining the third plate, at a position spaced apart from the first outer end portion in the direction of rotation of the rotary shaft, and
the second blade includes:
a second outer end portion adjoining the second plate; and
a second inner end portion adjoining the third plate, at a position spaced apart from the second outer end portion in the direction of rotation of the rotary shaft.

5. The sirocco fan of claim 1, wherein the first blade and the second blade are inclined in a direction opposite to the direction of rotation of the rotary shaft, nearing the third plate.

6. The sirocco fan of claim 1, wherein the first blade includes:
a first outer end portion adjoining the first plate; and
a first inner end portion adjoining the third plate, at a position spaced apart from the first outer end portion in a direction opposite to the direction of rotation of the rotary shaft, and
the second blade includes:
a second outer end portion adjoining the second plate; and
a second inner end portion adjoining the third plate, at a position spaced apart from the second outer end portion in a direction opposite to the direction of rotation of the rotary shaft.

7. The sirocco fan of claim 1, wherein the angle at which the first blade and the second blade are inclined with respect to the rotary shaft is 15 degrees or smaller.

8. An air conditioner comprising:
a case formed with an outside air inlet opening and an outside air supply opening through which air admitted through the outside air inlet opening passes;
a total heat exchanger disposed between the outside air inlet opening and the outside air supply opening;
an air supply fan disposed between the outside air supply opening and the total heat exchanger; and
an air supply fan motor having a rotary shaft that is coupled to the air supply fan,
wherein the air supply fan includes:
a first plate into which a rotary shaft of a motor is inserted;
a second plate spaced apart from the first plate in the extension direction of the rotary shaft;
a third plate disposed between the first plate and the second plate;
a first blade extending between the first plate and the third plate and inclined with respect to the rotary shaft; and
a second blade extending between the second plate and the third plate and inclined with respect to the rotary shaft.

9. The air conditioner of claim 8, wherein the direction in which the first blade is inclined toward the third plate is identical to the direction in which the second blade is inclined toward the third plate.

10. The air conditioner of claim 8, wherein the first blade and the second blade are inclined in the direction of rotation of the rotary shaft, nearing the third plate.

11. The air conditioner of claim 8, wherein the first blade includes:
a first outer end portion adjoining the first plate; and
a first inner end portion adjoining the third plate, at a position spaced apart from the first outer end portion in the direction of rotation of the rotary shaft, and
the second blade includes:
a second outer end portion adjoining the second plate; and
a second inner end portion adjoining the third plate, at a position spaced apart from the second outer end portion in the direction of rotation of the rotary shaft.

12. The air conditioner of claim 8, wherein the first blade and the second blade are inclined in a direction opposite to the direction of rotation of the rotary shaft, nearing the third plate.

13. The air conditioner of claim 8, wherein the first blade includes:
a first outer end portion adjoining the first plate; and
a first inner end portion adjoining the third plate, at a position spaced apart from the first outer end portion in a direction opposite to the direction of rotation of the rotary shaft, and
the second blade includes:
a second outer end portion adjoining the second plate; and
a second inner end portion adjoining the third plate, at a position spaced apart from the second outer end portion in a direction opposite to the direction of rotation of the rotary shaft.

14. The air conditioner of claim 8, wherein the first blade and the second blade are inclined toward a downstream side of the total heat exchanger, nearing the third plate.

15. The air conditioner of claim 8, wherein the first blade and the second blade are inclined toward an upstream side of the total exchanger, nearing the third plate.
